(19) United States
(12) Patent Application Publication
(10) Pub. No.: US 2025/0297701 A1
(43) Pub. Date: Sep. 25, 2025

(54) METHOD AND DEVICE FOR MAKING A T-BRANCH FOR PIPES

(71) Applicant: T-DRILL OY, Laihia (FI)

(72) Inventor: Leo LARIKKA, VANTAA (FI)

(21) Appl. No.: 18/863,026

(22) PCT Filed: Mar. 24, 2023
(86) PCT No.: PCT/FI2023/050168

§ 371 Date: Nov. 5, 2024

(30) Foreign Application Priority Data
May 19, 2022 (FI) 20225441

(51) Int. Cl. F16L 41/08; B26D 3/16

(52) U.S. Cl. CPC F16L 41/084; B21C 37/29; B21D 28/28; B23K 2101/06; B26D 3/164; B26F 1/0015; F16L 41/021

(57) ABSTRACT

The invention relates to a method and device for making a T-branch for a pipe by joining the shaped end of the branch pipe with internal welding to the ed-ges of a hole in the main pipe. The hole in the main pipe (T) and the arcs corresponding to the main pipe at the end of the branch pipe (P) are mechanically cut by removing one solid part from the hole and two (22) solid parts from the end of the branch pipe in a dry mechanical process, in which the cleanliness of the joint areas remains weldable. The shaped end of the branch pipe (P) is placed around the hole in the main pipe (T) and the joint seam between the pipes is welded by internal welding without a welding additive. A branch hole suitable for this is made by punching perpendicularly against the central axis of the main piped so that punch (1) pushes the piece that detaches from the main pipe into the punch hole (10) of the inner support (9).

The invention relates to a method and device for making a T-branch for a pipe by joining the shaped end of the branch pipe with internal welding to the edges of a hole in the main pipe.

The invention also relates to a device that can be used to make the hole in the main pipe required by the method. The aim of the present invention is that a suitable amount of material remains around the hole in the main pipe for welding the parts together from the inside without additional material being brought in from the outside.

The end of the branch pipe is cut into an arc suitable for the main pipe, e.g., using a method and device known from patent publication U.S. Pat. No. 10,537,948.

There are many ways to make a hole in a pipe to make a branch joint when making a T-branch of a pipe. For relatively small pipes, the most common method is drilling. Drilling produces chips and efficient drilling requires the use of cutting fluid. Chips and fluid are a disadvantage in the production and in the environment, because for butt welding, the chips must be removed and the parts must be cleaned, usually by washing with warm water. In addition, making a hole in a pipe by drilling is a relatively slow production method.

The simplest way to make a hole suitable for making a T-branch is the punching method, where the hole is punched with a round punch perpendicular to the longitudinal axis of the pipe. This works when the branch pipe is a certain amount smaller than the main pipe. The present invention is concerned with such a case. In patent application FI 20217012, a punching method and device are disclosed for making an oval hole in the wall of a pipe having a round cross-section. The hole serves to make the T-branch collar by bending and stretching the edges of the hole into a collar.

The aim of the invention is to provide a method and device by which the mechanical work steps of the parts of a T-branch can be carried out as a “dry process” without cutting oils and washings, enabling by using the punching method and a device suitable for it making in the main pipe a hole, to the edges of which the shaped end of a branch pipe smaller than the main pipe can be connected directly with internal welding.

In the method according to the invention, the hole in the main pipe (T) and the arcs corresponding to the main pipe at the end of the branch pipe (P) are mechanically cut by removing one solid part from the hole and two solid parts from the end of the branch pipe in a dry mechanical process, in which the cleanliness of the joint areas remains weldable, the main pipe being supported from the outside with retaining jaws, the main pipe being supported around the hole to be cut from the inside with an expandable inner support, the hole for the branch pipe is cut with a punch, which is moved perpendicularly against the central axis of the main pipe, guided by a guide hole in the second retaining jaw, the shaped end of the branch pipe (P) is placed around the hole in the main pipe (T) and the joint seam between the pipes is welded by internal welding without a welding additive.

Examples of a method and device for carrying out internal welding are disclosed in publications U.S. Pat. No. 6,433,307 (B1), EP 1633520 (B1) and WO 2019166689. Based on these, a person skilled in the art is able to use the invention as regards the feature concerning internal welding.

In the device according to the invention, a specially constructed inner support is used to prevent the shape of the main pipe from changing when the punch penetrates the wall of the main pipe into the punch hole of the inner support. The characteristics of the device are presented in claim 4.

When the branch pipe is smaller than the main pipe by a certain amount, the shape of the edges of the hole in the main pipe can be made to match the shape of the inner surface of the end of the branch pipe, so that the overlapping material thicknesses of the joint seam are suitable for welding the parts together from the inside without any additive brought in from the outside.

Preferred embodiments of the invention are disclosed in the dependent method and device claims.

In the following, the invention will be explained with the help of an exemplary embodiment with reference to the attached drawings, in which:

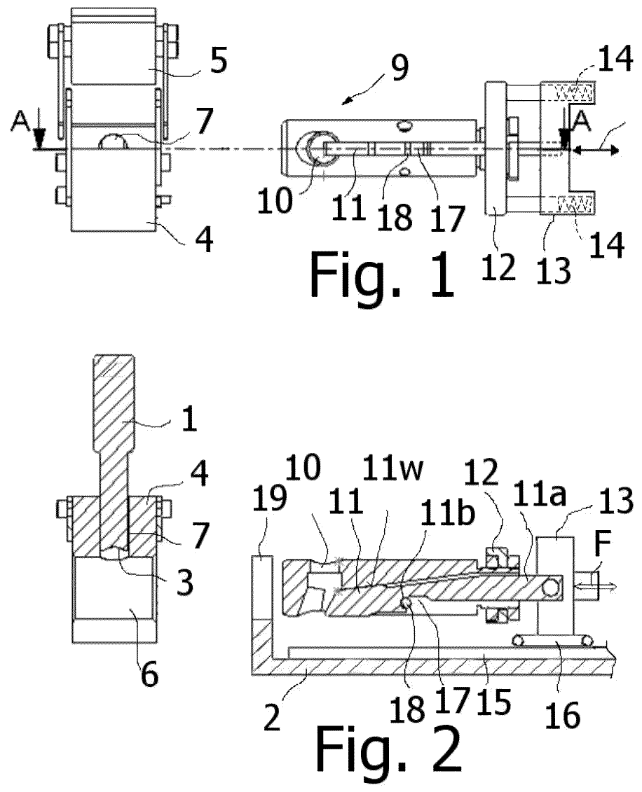

FIG. 1 shows the basic parts of the device used to carry out the method according to the invention, seen from below.

FIG. 2 shows a cross-section taken from FIG. 1 along the line A-A, with added frame 2, linear guide 15 and sliding carriage 16.

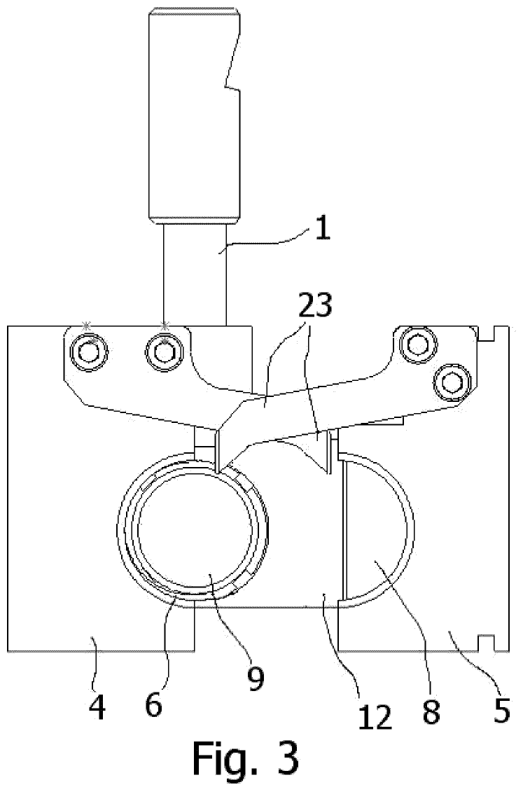

FIG. 3 shows the end view of the device according to FIG. 1.

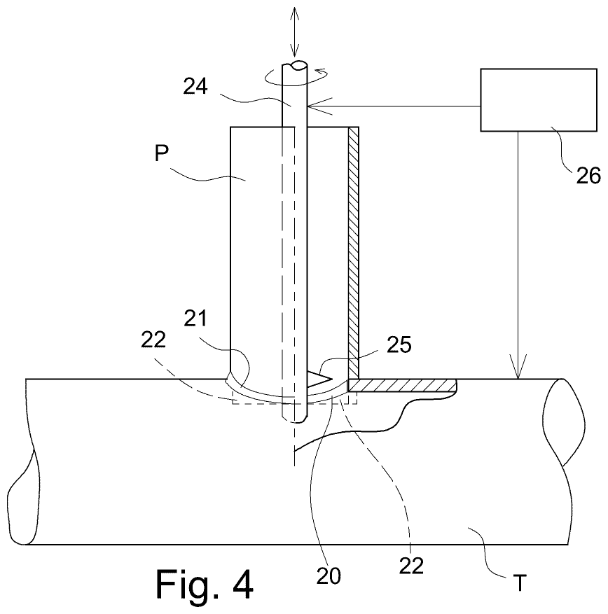

FIG. 4 shows a pipe T-branch made with the method and device according to the invention.

The branch hole 20 (FIG. 4) is punched into the main pipe T with punch 1, which is round in cross-section. The cutting blade 3 of punch 1 has a steel edge, the two lowest points of which being at a distance from each other corresponding to the longitudinal direction of the pipe to be punched (FIG. 2). In this case, the cutting force is not directed as a shock, but rather as a incision, and the detaching part is shaped and detached in a controlled manner.

During punching, the pipe is supported from the outside with retaining jaws 4, 5. The retaining jaws 4 and 5 include support troughs 6, 8 for receiving the pipe to be punched. The curvature of the support troughs corresponds to the curvature of the outer surface of the main pipe T. In the main pipe supporting position, the retaining jaws 4 and 5 remain slightly separated from each other. The second retaining jaw 5 can be moved back and forth so that the pipe can be placed between the retaining jaws 4 and 5 in the clamping grip of troughs 6 and 8.

The first part 4 of the retaining jaws has a punch guide hole 7 for receiving punch 1. The guide hole 7 has a central axis in the direction of movement of punch 1, which is perpendicular to the central axis of the cylinder formed by the surfaces of the support troughs 6, 8 in the pipe-supporting position. In this case, the central axis of punch 1 is oriented perpendicularly against the central axis of pipe T, when pipe T is between the retaining jaws 4 and 5, supported by support troughs 6, 8 in the pipe-supporting position.

The punching device also comprises an inner support 9 for supporting main pipe T from the inside during punching. The inner support is needed to prevent deformation of the main pipe T to be cut during the cutting situation, when the punch penetrates the wall. The inner support has a punching hole 10 that accommodates punch 1 and expands downwards to allow the detaching piece to fall out of the inner support when inner support 9 is pulled out of the pipe. The inner support 9 must support the pipe close to the outer edge of punch 1, i.e. immediately around punch hole 10. The inner support is round in cross-section and dimensioned to fit loosely inside pipe T. The inner support 9 comprises a longitudinally movable wedge 11, which is arranged to press the upper surface 9 of the inner support against the inner surface of pipe T. Punch 1 is arranged to be inserted into the punch hole 10 when the inner support 9 is in place inside the pipe in the support position. Due to the round shape of the inner support (9), its upper surface rests against the inner surface of the main pipe around punch hole (10).

The inner support 9 is arranged to be moved into and out of the support position by one actuator F, which is arranged to first move the inner support 9 with its wedge 11 to the support position via slider 13, wedge arm 11a and springs 14. The force required for this movement is smaller than the force required to change the shape of springs 14 (compress the compression springs) against the spring force, in which case the springs 14 act as fixed pins pushing fastener 12 of the inner support 9 forward. Wedge arm 11a is attached to slider 13, which is moved back and forth by actuator F. Actuator F is typically a piston cylinder device. In the case shown, two compression springs 14 are attached between fastener 12 and slider 13. Slider 13 is on top of a sliding carriage 16 moving on linear guide 15. The linear guide 15 is supported on frame 2, which is connected to fixed restraints 19, between which the inner support 9 is able to pass. Restraints 19 act as a motion limiter for the inner support 9. When fastener 12 collides with restraints 19 of the frame, actuator F moves only wedge 11 via slider 13 and wedge arm 11a against the force of springs 14, whereby inner support 9 is wedged into the support position. In this case, the inner support 9 is held in the support position by means of fastener 12 leaning against restraint 19. On the sides of slider 13 and fastener 12 there are slide guides (not shown in the figures) attached to frame 2, which support the structure formed by fastener 12 and slider 13.

Wedge 11 has a first wedge surface 11w, which is arranged to press the inner support 9 against the inner surface of the pipe, when actuator F moves the wedge 11 relative to the inner support 9 from right to left in FIG. 2. The movement of wedge 11 continues until the inner support 9 rests against the inner surface of the pipe with sufficient force. Punch 1 moves into the punch hole 10 in the inner support 9 when inner support 9 is stationary inside the pipe in the support position. After punching, actuator F pulls the slider 13 and wedge 11 in the opposite direction, whereby the force of springs 14 holds the inner support in place until wedge surface 11w moves sufficiently to release the inner support 9 from the support pressure. A second wedge surface 11b of wedge 11 and pin 18 of the inner support are arranged to lift wedge 11 out of contact with the inner surface of the pipe, when the transfer movement of slider 13 continues from left to right. Wedge 11 has a groove 17 into which pin 18 of the inner support extends. With the help of groove 17 and pin 18, wedge 11 pulls the inner support 9 backwards away from the support position. In the wedging stage, with the help of wedge surface 11w, groove 17 does not limit the movement between the inner support 9 and wedge 11, which continues 20 until the inner support rests against the inner surface of the pipe with sufficient force. In this way, the free end of wedge 11 extends into the expanding lower part of punch hole 10.

In order to make the branch hole to the pipe, punch 1 is guided by guide hole 7 to run perpendicularly against the central axis of the pipe.

FIG. 4 illustrates the design of the end of branch pipe P so that it is suitable for connecting by internal welding to hole 20 formed as described above. The cutting depth and curvature of parts 22 to be removed from the end of branch pipe P are adjusted so that the end of branch pipe P sits on the outer surface of main pipe T immediately around the edges of hole 20. In this case, a suitable amount of material to be melted during welding is obtained at the seam.

By using the device described above, a hole can be cut in the main pipe by the following method steps:
the main pipe is taken in its axial direction between the retaining jaws 4, 5 to the punching position of the main pipe (T);
the retaining jaws 4, 5 are brought in contact with the main pipe to hold the main pipe in the punching position;
the inner support 9 and wedge 11 belonging to the inner support are moved into the main pipe;
transfer motion of the inner support 9 is stopped in a position where the round punch hole 10 in the inner support is located in the trajectory of punch 1 at the hole to be formed in the main pipe;
movement of wedge 11 in relation to inner support 9 is continued in order to press the inner support against the inner wall of the main pipe (T) around punch hole 10;
the punch 1 is guided to move, guided by guide hole 7, towards the central axis of the main pipe, whereby the cutting blade 3 of the punch pierces the wall of the main pipe T and removes one solid part from the hole 20 created in the wall into punch hole 10;
the wedge 11 is moved in the direction opposite to the previous direction of movement in order to release the inner support 9 from the pressure against the inner surface of the main pipe;
the inner support 9 and wedge 11 are moved away from inside the main pipe;
the retaining jaws 4, 5 are opened and the punched main pipe is released from the retaining jaws 4, 5.

The punched pipe has to be removed from the retaining jaws 4 and 5 with special extractors 23, which are attached to the retaining jaws. When the retaining jaws 4 and 5 are moved away from each other, hook-like extractors 23 pull the pipe out of the support troughs 6, 8.

Accordingly, punch 1 is used to remove one solid part from the wall of main pipe T. Two curved pieces are also removed from the end of branch pipe P, the curvature of the cutting surface of which corresponding to the curvature of the outer surface of the main pipe. Finally, the shaped end of branch pipe P is placed around hole 20 of the main pipe and joint seam 21 between the pipes is welded with internal welding without welding additive, melting together the materials of the overlapping joint edges. Shown in FIG. 4 is an electrode arm 24 and electrode 25, the tip of which is guided along a path following the joint seam 21 by rotating the electrode arm and at the same time moving it back and forth. Power source 26 is used to create a voltage between electrode 25 and the pipes. The voltage is adjusted so that the arc between electrode 25 and the joint seam melts the materials of joint seam 21 into one wall that merges with the walls of pipes T and P.

1. A method for making a T-branch for a pipe by joining a shaped end of a branch pipe with internal welding to edges of a hole in a main pipe, the method comprising:
mechanically cutting the hole (20) in the main pipe (T) and arcs corresponding to the main pipe at the end of the branch pipe (P) by removing one solid part from the hole and two (22) solid parts from the end of the branch pipe in a dry mechanical process, in which the cleanliness of the joint areas remains weldable, the step of mechanically cutting including:
supporting the main pipe from its outside with retaining jaws (4, 5),
supporting the main pipe from its inside around the hole to be cut with an expandable inner support (9, 10, 11), by moving the expandable inner support (9, 10, 11) into the main pipe,
cutting the hole (20) for the main pipe with a punch (1), which is moved perpendicularly against the central axis of the main pipe, wherein the punch is guided by a guide hole (7) in the second retaining jaw (4),
moving the inner support (9, 10, 11) from inside the main pipe, the shaped end of the branch pipe (P) being placed around the hole in the main pipe (T), and
internally welding the joint seam (21) between the pipes is without a welding additive.

2. The method according to claim 1, wherein the step of cutting the hole in the main pipe includes:
taking the main pipe in its axial direction between retaining jaws (4, 5) to the punching position of the main pipe (T);
bringing the retaining jaws (4, 5) in contact with the main pipe to hold the main pipe in the punching position;
moving the inner support (9) and wedge (11) belonging to the inner support into the main pipe;
stopping transfer motion of the inner support (9) in a position where the round punch hole (10) in the inner support is located in the trajectory of punch (1) at the hole to be formed in the main pipe;
continuing movement of wedge (11) in relation to the inner support (9) in order to press the inner support against the inner wall of the main pipe (T) around the punch hole (10);
guiding the punch (1) to move, guided by the guide hole (7), towards the a central axis of the main pipe, whereby the cutting blade (3) of the punch pierces the wall of the main pipe and removes one solid part from the hole (20) created in the wall into punch hole (10);
moving the wedge (11) in the direction opposite to the previous direction of movement in order to release the inner support (9) from the pressure against the inner surface of the main pipe;
moving the inner support (9) and wedge (11) away from inside the main pipe;
opening the retaining jaws (4, 5) and releasing the punched main pipe from the retaining jaws (4, 5).

3. The method according to claim 2, characterized in that the inner support (9) is pressed against the inner surface of the pipe with wedge (11), which is moved back and forth in relation to the inner support (9) with the same actuator (F) that moves the inner support (9) into and out of the support position, and that the inner support (9) is first moved with its wedge (11) to the support position via the wedge arm (11a) and spring (14) and then to the support position by only moving the wedge (11) via wedge arm (11a) against the force of said spring (14).

4. A device for making a branch hole in a pipe by the method according to features listed in claim 2, wherein the device comprises
punch (1), which is round in cross-section,
a cutting blade (3) at the end of the punch,
retaining jaws (4, 5) for supporting the pipe from the outside during the punch, the retaining jaws comprising support troughs (6, 8) for receiving the pipe to be punched,
a punch guide hole (7) receiving the punch (1) in the first part (4) of the retaining jaws, the guide hole (7) having in the direction of movement of punch (1) a central axis, which is in the pipe support position perpendicular to the central axis of the cylinder formed by the surfaces of the support troughs (6, 8), and
an inner support (9) to support the pipe from the inside during the punch, the inner support comprising a round punch hole (10), that wherein the inner support (9) is arranged to be moved into the main pipe and away from inside the main pipe, wherein the inner support (9) comprises a longitudinally movable wedge (11), which is arranged to press the inner support (9) against the inner surface of the pipe, and wherein the punch (1) is arranged to be inserted into the punch hole (10) when the inner support (9) is in place inside the pipe in the support position, the inner support (9) being designed to have its upper surface resting against the inner surface of the main pipe around the punch hole (10).

5. The device according to claim 4, characterized in that the cutting blade (3) of the punch (1) has a steel edge, the two lowest points of which being at a distance from each other corresponding to the longitudinal direction of the pipe.

6. The device according to claim 4, characterized in that the inner support (9) is arranged to be moved into and out of the support position by one actuator F, which is arranged to first move the inner support (9) with its wedge (11) into the support position via the wedge arm (11a) and spring (14) and then move only wedge (11) via the wedge arm (11a) against the force of said spring (14), whereby the inner support (9) is wedged into the support position.

7. The device according to claim 4, characterized in that the wedge (11) has a first wedge surface (11w), which is arranged to press the inner sup-port (9) against the inner surface of the pipe, and another wedge surface (11b), which is arranged to lift the wedge (11) from the inner surface of the pipe.

8. The device according to claim 6, characterized in that the wedge (11) has a first wedge surface (11w), which is arranged to press the inner sup-port (9) against the inner surface of the pipe, and another wedge surface (11b), which is arranged to lift the wedge (11) from the inner surface of the pipe.
